(19) United States
(12) Patent Application Publication
(10) Pub. No.: US 2023/0342642 A1
(43) Pub. Date: Oct. 26, 2023

(54) SYSTEM AND METHOD FOR MANAGING A USER-CONTROLLABLE DEVICE

(71) Applicant: Invention AI, Austin, UM (US)

(72) Inventors: Edwin De Angel, Austin, TX (US); Kartik Nanda, Austin, TX (US); Trenton Grale, Austin, TX (US)

(21) Appl. No.: 17/727,694

(22) Filed: Apr. 22, 2022

(51) Int. Cl. G06N 5/04; G10L 15/22

(52) U.S. Cl. CPC G06N 5/043; G10L 15/22

(57) ABSTRACT

Disclosed is a system for managing a user-controllable device. The system comprises at least one artificial intelligence engines comprising at least a first audio-based artificial intelligence; and at least one processor implementing a master finite state machine in software. The at least one processor is configured to: provide a predefined set of operations in one of a plurality of states of the master finite state machine to the user; receive voice input from the user relating to one of an operation from the predefined set of operations; determine at least one function of the user-controllable device based on the voice input from the user and state in which the voice input was received, using at least one artificial intelligence engine; and perform the at least one function of the user-controllable device.

### TECHNICAL FIELD

The present disclosure relates generally to artificial intelligence; and more specifically, to voice-based assistants.

### BACKGROUND

Artificial intelligence is a technology that is transforming every walk of life. This technology is a wide-ranging tool that enables people to integrate information, analyze data and use resulting insights to improve decision making. Furthermore, artificial intelligence has novel applications in finance, national security, health care, legal system, transportation, and so forth, and addresses issues such as data access problems, algorithmic bias, and so forth. During the last few years, significant advances in voice recognition have been made and products like Siri®, Cortana®, and Alexa® have come to the market. Herein, these products have focused on the creation of a voice assistant capable of understanding any type of request or any type of question-based on an extensive voice recognition dictionary.

Typically, the main results are very complex systems used by people for certain occasional tasks like checking the weather, determining traffic, playing music, reading news, and so forth. However, these systems are too cumbersome, inaccurate, or tedious to be effective tools, that transform the productivity of most people.

An additional challenge is that many businesses have a strong policy regarding privacy ethos, and voice assistants using a cloud-based solution is not viable, as the cloud-based solution may store confidential files and the confidential files may leak as a result of hacking. Moreover, a delay is added while using the internet to retrieve or store information in many cloud-based solutions, wherein the delay is too long for real-time systems. Additionally, the current voice-based assistants are not optimized for a real-time system, such as, but not limited to, a drive-through system of a restaurant. Furthermore, the current voice-based assistant will need to know the contents of a menu as presented by the drive-through system of the restaurant and will need to transmit the request or order of a customer to the cloud. However, many customers are not comfortable with their voice being collected by a voice-based assistant and being stored in the cloud due to privacy concerns.

Additionally, environmental noise in the background from other cars, people, motors, and so forth becomes a source for false positives and leads to the voice-based assistant misunderstanding the request of the user or that of the customer. Conventionally, a typical voice-based assistant is not able to distinguish whether the user is responding to the queries presented by the voice-based assistant or not. Moreover, battery life often becomes a major issue when a device implements a voice-based assistant, with the energy efficiency of the device depleting faster than normal usage the device.

Therefore, in light of the foregoing discussion, there exists a need to overcome the aforementioned drawbacks associated with voice-based assistants.

### SUMMARY

The present disclosure seeks to provide a system for managing a user-controllable device. The present disclosure also seeks to provide a method for managing a user-controllable device. The present disclosure aims to provide a solution that overcomes at least partially the problems encountered in the prior art.

In one aspect, the present disclosure provides a system for managing a user-controllable device, the system comprising:
at least one artificial intelligence engine comprising at least a first audio-based artificial intelligence; and
at least one processor implementing a master finite state machine in software, the at least one processor is configured to:
   provide a predefined set of operations in one of a plurality of states of the master finite state machine to the user;
   receive voice input from the user relating to one of an operation from the predefined set of operations;
   determine at least one function of the user-controllable device based on the voice input from the user and state in which the voice input was received, using the at least one artificial intelligence engine; and
   perform the at least one function of the user-controllable device.

In another aspect, the present disclosure provides a method for managing a user-controllable device, wherein the method is implemented using a system comprising at least one artificial intelligence engine comprising at least one audio-based artificial intelligence engine; and at least one processor implemented as a master finite state machine in software, the method comprising:
providing a predefined set of operations in one of a plurality of states of the master finite state machine to the user;
receiving voice input from the user relating to one of an operation from the predefined set of operations;
determining at least one function of the user-controllable device based on the voice input from the user and state in which the voice input was received, using the at least one artificial intelligence engine; and
performing the at least one function of the user-controllable device.

Embodiments of the present disclosure substantially eliminate or at least partially address the aforementioned problems in the prior art, and enable an efficient voice-based assistant.

Additional aspects, advantages, features, and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those skilled in art will understand that the drawings are not to scale. Wherever possible, like elements have been indicated by identical numbers.

Embodiments of the present disclosure will now be described, by way of example only, concerning the following diagrams wherein:

FIG. 1 is a figure of a system for managing a user-controllable device, in accordance with an embodiment of the present disclosure;

FIG. 2 is a block diagram comprising a predefined set of operations, in accordance with an embodiment of the present disclosure;

FIGS. 3A and 3B collectively show an illustration of visual overlayer, in accordance with an embodiment of the present disclosure;

FIG. 4 is a lookup table of a configuration file, in accordance with an embodiment of the present disclosure;

FIG. 5A is an exemplary illustration of a user-controllable device, in accordance with an embodiment of the present disclosure;

FIG. 5B is shown inputs and outputs of a master finite state machine as implemented by the user-controllable device, in accordance with an embodiment of the present disclosure; and

FIG. 6 is an illustration of a flowchart depicting steps of a method for managing a user-controllable device, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a system for managing a user-controllable device, the system comprising
at least one artificial intelligence engine comprising at least a first audio-based artificial intelligence engine; and
at least one processor implementing a master finite state machine in software, wherein the at least one processor is configured to:
   provide a predefined set of operations in one of a plurality of states of the master finite state machine to the user;
   receive voice input from the user relating to one of an operation from the predefined set of operations;
   determine at least one function of the user-controllable device based on the voice input from the user and state in which the voice input was received, using the at least one artificial intelligence engine; and
   perform the at least one function of the user-controllable device.

In another aspect, an embodiment of the present disclosure provides a provides a method for managing a user-controllable device, wherein the method is implemented using a system comprising at least one artificial intelligence engine comprising at least one audio-based artificial intelligence engine; and at least one processor implemented as a master finite state machine in software, the method comprising:
providing a predefined set of operations in one of a plurality of states of the master finite state machine to the user;
receiving voice input from a user relating to one of an operation from the predefined set of operations;
determining at least one function of the user-controllable device based on the voice input from the user and the state in which the voice-input was received, using the at least one artificial intelligence engine; and
performing the at least one function of the user-controllable device.

Under the embodiments of the present disclosure, the system and method improve current artificial intelligence technology by implementing the system and the method in an edge computing device. Herein, the edge computing device strengthens the privacy of a confidential file for any business, as the edge computing device does not rely on a cloud for storing and retrieving information. Beneficially, the present disclosure solves latency experienced while receiving or storing information in a cloud. Additionally, the present disclosure supports understanding short phrases and is capable of carrying out a conversation. Advantageously, the data size requirements of the system are reduced. Moreover, an additional audio-based artificial intelligence engine complements the first audio-based artificial intelligence to determine the mood of a user. Practically, the present disclosure is quite versatile and may be used in various applications, such as for web browsing, an intelligent vending machine, a drive-through system, a smart PDF reader, a smart elevator, a voice app, and so forth.

Throughout the present disclosure, the term “user-controllable device” refers to an electronic device associated with (or used by) a user that is capable of enabling the user to perform specific tasks associated with the aforementioned system. Furthermore, the user-controllable device is intended to be broadly interpreted to include any electronic device that may be used for voice and/or data communication over a wireless communication network. Examples of user-controllable devices include, but are not limited to, cellular phones, personal digital assistants (PDAs), handheld devices, wireless modems, laptop computers, personal computers, etc. Moreover, the user-controllable device may alternatively be referred to as a mobile station, a mobile terminal, a subscriber station, a remote station, a user terminal, a terminal, a subscriber unit, an access terminal, etc. Additionally, the user-controllable device includes a casing, a memory, a processor, a network interface card, a microphone, a speaker, a keypad, and a display. Furthermore, the user-controllable device may be applications on a phone, such as an application that teaches music, or plays videos, or consumes PDF files. Alternatively, the user-controllable device may be a physical machine, such as an elevator or a vending machine.

Optionally, the user-controllable device is an edge computing device. Herein, the edge computing device is hardware that controls data flow at the boundary between two networks. Furthermore, edge computing devices are used to accomplish various tasks depending on software applications or features they are provisioned with. Examples of the edge computing device include, but are not limited to, routers, routing switches, integrated access devices, multiplexers, a diverse range of metropolitan area network (MAN) and wide area network (WAN) access devices, smartphones, hardware platforms like Raspberry Pi®, embedded systems using a printed circuit board, desktop computers, laptop computers, tablets. Moreover, edge computing devices are operably coupled to carrier and service provider networks. Typically, edge computing devices working as routers include quality of service (QoS) and multi-service functions to manage different types of network traffic. Furthermore, edge computing devices may translate between one type of network protocol and another.

In an embodiment, a hybrid system may be implemented wherein the main artificial engine of the plurality of the artificial intelligence engines resides on the edge-computing device. Alternatively, the user-controllable device comprising the plurality of artificial intelligence engines may consult another artificial intelligence residing in a cloud.

The system comprises at least one artificial intelligence engine comprising at least a first audio-based artificial intelligence engine. Herein, the at least one artificial intelligence engine comprises tools that help build an artificially intelligent system, wherein these tools help to reiterate tasks that are repetitive and difficult to achieve by a human. Examples of the at least one artificial intelligence engine include, but are not limited to, Cortana®, Google Assistant®, Siri®. Furthermore, the present disclosure simplifies users' interactions with machines and applications. Herein, the applications may be on a mobile phone device, such as an application that teaches music, or plays videos, or consumes PDF files. Additionally, the system may be physical machines, such as an elevator or a vending machine. Herein, the first audio-based artificial intelligence engine comprises an automated speech recognition (ASR) technology, that converts spoken words into written text. Furthermore, the ASR technology allows user-controllable devices to identify and process the spoken words a person speaks into an input device or microphone connected to the user-controllable device.

Optionally, the at least one artificial intelligence engine further comprises at least one of: a video-based artificial intelligence engine, a sensor based artificial intelligence engine. Herein, the video-based artificial intelligence engine uses machine learning models to automatically recognize a vast number of objects, places, and actions in stored or streaming video inputs. The sensor-based artificial intelligence engine is used to simulate a variety of human and beyond-human capabilities. They, further provide environmental feedback regarding surroundings. For instance, a self-driving vehicle may comprise sensors to detect objects around the self-driving vehicle, determine distance of said objects with respect to the self-driving vehicle, determine proximity of said objects to the self-driving vehicle, and so forth.

In a first example, the user-controllable device may be placed in a restaurant, wherein the user-controllable device is a drive-through system. Herein, the drive-through system usually comprises a restaurant building with a driveway wrapped around the restaurant building. Typically, a driver approaches either a first window or a microphone box along with a camera and place an order, wherein a drive-through menu is available at either the first window or the microphone box. Herein, the driver places an order via the microphone box, with the camera capturing the face of the driver. Subsequently, the first audio-based artificial intelligence engine processes sentences spoken by the driver to extract the order placed, and the video-based artificial intelligence engine comprises the camera. Subsequently, the camera serves as an input to implement eye-tracking of the user and perform facial recognition, which may be used to determine the intended order of the user and correlate with the order extracted from the first audio-based artificial intelligence engine. Advantageously, facial recognition may identify the user as a regular user and correlate the current order with the frequent order pattern of the user.

Optionally, the first audio-based artificial intelligence engine is configured to determine the context of the voice input using at least one of the state diagrams, flow diagrams, classical graph theory. Herein, the state diagram is a behavioral diagram that represents a behavior or represents the condition of the system or part of the system at finite instances of time, using finite state transitions. Furthermore, the flow diagram is a graphic representation that shows the sequence of steps and decisions needed to perform a process. Herein, each step in a sequence is noted within a diagram shape. Subsequently, the steps are linked by connecting lines and directional arrows. As a result, the flow diagram allows the user to easily and logically follow the process from beginning to end. Moreover, in classical graph theory, information involving relations between elements is expressed, and relations are denoted by edges, and elements are denoted by nodes. Typically, the first audio-based artificial intelligence engine comprises recognizing words or phrases in the context of a process. Herein, words, phrases, images, or inputs at each node are used to train the system in the present disclosure and decide the next state or decision to be made. Additionally, the system possesses inherent visibility which helps in forming a basic understanding of the state of the input, and action caused by the state of the input, wherein the data and training of the system are considered to be edges.

Optionally, the first audio-based artificial intelligence engine is configured to enable conversational interactions with the user by employing the determined context of the voice input. Herein, the conversational interactions configured by the audio-based artificial intelligence engine utilize a set of technologies behind automated messaging and speech-enabled applications that offer human-like interactions between computers and humans. Typically, conversational interactions combine natural language processing (NLP) with machine learning. Furthermore, the conversational interactions configured by the first audio-based artificial intelligence engine enable potential users to interact with the user-controllable device and answer primary questions that the user may have. Moreover, conversational interactions are possible since the audio-based artificial intelligence engine implements a pre-defined process and all the possible options have been previously considered. Additionally, conversational interactions are often performed by training the first audio-based artificial intelligence engine with the most common responses used by the users during normal interactions. Continuing from the first example, in the context of the drive-through system, the user-controllable device will be able to understand the type of meal, size of the meal, quantity of the meal, and so forth.

Throughout the present disclosure, the term “processor” refers to a computational element that is operable to respond to and processes instructions that drive the system. Optionally, the processor includes but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices, and various elements associated with a processing device that may be shared by other processing devices. Additionally, one or more individual processors, processing devices, and elements are arranged in various architectures for responding to and processing the instructions that drive the system.

The system comprises at least one processor implementing a master finite state machine in software. Herein, the master finite state machine is an abstract machine that is in exactly one of a finite number of states at any given time. Furthermore, the master finite state machine can transition from one state to another in response to some inputs. Typically, the master finite state machine is defined by a list of states, initial states, and inputs that trigger each transition. Practically, the functioning of the master finite state machine is observed in many devices used in daily lives that perform a predetermined sequence of actions depending on a sequence of events with which they are presented. Continuing from the first example, the master finite state machine implements a process of the drive-through system, wherein the drive-through system comprises multiple states and records the actions of the driver based on the action mentioned in the multiple states. Herein, the multiple states may comprise a first state, as denoted by “State1”, a second state, as denoted by “State2”, a third state, as denoted by “State3”, a fourth state, as denoted by “State4”, a fifth state, as denoted by “State5”, a sixth state, as denoted by “State6” and a seventh state, as denoted by “State7”. Furthermore, the first state “State1” records salutation, the second state “State2” records main entry, the third state “State3” records options for the main entry, the fourth state “State4” records side dishes, the fifth state “State5” records the size of the side dishes, the sixth state “State6” records the type of drink and the seventh state “State7” records the size of the drink. Subsequently, flow through the drive-through system may be driven by questions performed by the drive-through system, such that the drive-through system may lead the user through a sequence of the process.

Optionally, the master finite state machine and the predefined set of operations are optimized based on the user-controllable device. Herein, the process in the drive-through system may be trained in such a way that the sequence of the questions involving the multiple states is not important as long as all the questions are covered.

Optionally, the master finite state machine is generated using a scripting language. Herein, the scripting language is a programming language that automates execution of tasks or the multiple states that would otherwise be performed individually by a human operator. Examples of scripting language include, but are not limited to, JavaScript®, Python®. Typically, the scripting language may be used to automate application software, text editors, web pages, operating system shells, embedded systems, and computer games. Furthermore, the master finite state machine is generated using the scripting language, wherein the scripting language has a looping behavior that constantly evaluates the current situation in a loop or with events.

Optionally, the master finite state machine is configured to selectively activate the at least one artificial intelligence engine based upon a current state thereof. Herein, the implementation of the master finite state machine allows to turn off the first audio-based artificial intelligence engine and the video-based artificial intelligence engine and parts of the electronic system. For instance, the video-based artificial intelligence engine may be required only at the beginning for facial recognition, to identify a user. Alternatively, the video-based artificial intelligence engine may be switched on only during the first state, as denoted by “State1” but may be switched off during the rest of the sequence. Advantageously, this makes the system very power efficient, wherein the at least one artificial intelligence engine is used only when necessary. Continuing from the first example, the user-controllable device may further comprise a motion sensor. Herein, a primary state may be a motion sensor detecting the presence of the driver near the user-controllable device. At this primary state, the voice input of the first audio-based artificial intelligence engine and the camera present in the video-based artificial intelligence engine may be turned off until a motion is detected. Once the user is detected with the help of the motion sensor, the system follows the steps implemented in the master finite state machine. In a secondary state, the camera may be turned on and the face of the driver may be recorded to compare with a historical database and make a suggestion based on prior orders of the driver. Once this state has been completed, the camera remains off for the other states in the system. Alternatively, a log file may be kept to keep track of the multiple states, inputs to the master finite state machine, and output of the master finite state machine, wherein the outputs of the master finite state machine is used to determine at all times the reason behind a particular behavior of the master finite state machine.

Optionally, the at least one processor is further configured to generate and maintain a log file to record at least one of:
inputs/outputs to/of the master finite state machine;
inputs/outputs to/of the at least one artificial intelligence engine; and/or
the plurality of states of the master finite state machine.

In this regard, the log file is used to keep track of the plurality of states, inputs to, and output of the master finite state machine, wherein the outputs of the master finite state machine is used to determine at all times the reason behind a particular behavior of the master finite state machine. Furthermore, the log file is used to track all triggering events causing the finite state transitions in the master finite state machine while recording the sequence of events, for debugging and simulation to understand the recorded sequence of events. The log file further records the at least one function based on the voice input and the state of the voice input, output of the at least one artificial intelligence engine and tracks current data set version used in the at least one artificial intelligence engine, thereby allowing to identify if a new sequence of events is caused by a new artificial intelligence engine introduced in a newer release of the at least one artificial intelligence engine. Beneficially, the log file provides visibility to the system of the present disclosure by recording internal state variables and the sequence of events. This sequence of events may be used to simulate and understand the current behavior of the system and future enhancements.

The at least one processor is configured to provide a predefined set of operations in one of a plurality of states of the master finite state machine to the user. Herein, the predefined set of operations is a reduced command set, wherein the reduced command set is used to facilitate adoption by the user. Additionally, the predefined set of operations comprises a combination of keywords and numbers. Herein, the keywords are common commands, and the numbers may be arguments or subcommands depending on the application or place in the application. For instance, a video player may comprise a keyword to play a video, wherein the keyword is labeled as “Play”. Herein, the video player comprises potential videos, wherein the potential videos to be played are numbered. Furthermore, the potential videos may comprise a first video, as denoted by “1”, a second video, as denoted by “2” and a third video, as denoted by “3”. In case, the user wants to play the third video, the user will say “Play 3”, and the system will the third video, denoted by “3”. Subsequently, the system labels the potential videos to be played with a respective number. Furthermore, the predefined set of operations that uses the reduced command set is closely related to the process being implemented, thereby reducing data size requirements.

Optionally, the at least one processor comprises providing the predefined set of operations and function selection on a visual overlayer on the user-controllable device. Herein, the visual overlayer is coupled with a natural language-based verbal interface. Furthermore, the natural language-based verbal interface allows the user to control underlying actions of the user-controllable device by speaking naturally to the user-controllable device, wherein the user-controllable device is considered to be human-like. Additionally, the visual overlayer provides feedback and information to the user. Moreover, the visual overlayer is transparent which enables printing the predefined set of operations on any screen indicating to the user the possible predefined set of operations. Subsequently, the visual overlayer provides feedback by highlighting a particular command from the predefined set of operations decided by the user, to show that the particular command is understood. Additionally, the particular command is highlighted for a couple of seconds, wherein time is variable. Moreover, the visual overlayer may be used as a detector or a tracker tool, whereby images are received from a camera, a file, video, or sensor and are actively scanned by the visual overlayer using the plurality of artificial intelligence engines. Consequently, upon detection of targets on a screen, the targets are classified, labeled on the visual overlay, and ready for another command out of the predefined set of operations by the user.

In an embodiment, the video-based artificial intelligence engine may add additional information, such as labels on the visual overlayer or multiple layers where every layer overlays information on top. In one instance, there may be a predefined set of operations to track a particular automaker in a parking lot. Herein, in one layer the system shows a potential automaker that the system recognizes. Subsequently, once the command is given, a car belonging to the chosen automaker will be highlighted through a layer overlapping a video pointing to a parking lot or a picture of the parking lot. In another instance, an individual monitors a camera that looks onto a crowd. Herein, the user may label people in the crowd, as a result of which the system will highlight and label people in the image, namely a first-person as “P1”, a second person as “P2”, and a third person as “P3”. Subsequently, the user might ask to track the second person, given by the label “P2”. Consequently, the visual overlayer will track the second person, given by the label “P2”, on a different layer to easily comprehend the activities of the second person “P2”.

The at least one processor is configured to receive the voice input from the user relating to one of an operation from the predefined set of operations. Subsequently, the voice input is processed at the user-controllable device. In a second example, a multistoried residential building comprises an elevator. Owing to the presence of deadly viruses and germs and fearing spreading of the same, a touchless interface is implemented inside the elevator. Herein, the touchless interface of the elevator comprises a microphone and a speaker, wherein the elevator uses the speaker to ask the user regarding the floor that the user wants to reach. Subsequently, and the user verbalizes the floor number in form of the voice input to the microphone.

Optionally, the at least one processor is further configured to receive a video input to determine at least one function of the user-controllable device. Continuing with the second example, two individuals enter the elevator, wherein the two individuals reside on different floors of the multistoried residential building. However, the two individuals are talking between themselves regarding the floor that they want to go to and fail to respond to verbal cues given by the elevator enquiring to them about the same. Advantageously, with the assistance of the video-based artificial intelligence engine working in conjunction with the first audio-based artificial intelligence engine, the video input received from the elevator may be used for eye tracking and decide that the two individuals were not talking to the elevator and disregard that input as a whole.

The at least one processor is configured to determine at least one function of the user-controllable device based on the voice input from the user and state in which the input was received, using at least one artificial intelligence engine. Herein, the at least one function may be either equal to or more than the predefined set of operations. Herein, an adaptive artificial intelligence engine is used to increase the accuracy of determining at least one function of the user-controllable device, thereby increasing the reliability of the system. In particular, the adaptive artificial intelligence engine easily adapts to new information and provides insights almost instantaneously. Continuing from the first example, the first audio-based artificial intelligence engine processes the sentences to extract the order of the user, the camera serves as an input to implement eye-tracking and perform facial recognition, which is subsequently used to determine what the user intend to order and correlate it with the first audio-based artificial intelligence engine extracted order.

Optionally, the at least one processor is configured to enable the selection of a user profile from a user profile database. Herein, the user-controllable device may cater to different users, wherein each user has their own specific set of commands which they use often, thereby performing a particular set of functions. Furthermore, a first user may use a command, denoted by “P1” and a given task that will be automated. Alternatively, a second user may use the same command “P1” to perform a different set of functions. Herein, the at least one artificial intelligence engine may identify the user as a regular user and correlate at least one function with the frequent pattern of the user. Consequently, the user profile database is created to store information related to the first user, the second user, and so forth.

The at least one processor is configured to perform at least one function of the user-controllable device. Herein, the at least one function is performed through the combination of the first audio-based artificial intelligence engine and the video-based artificial intelligence engine, wherein at least one function may be commonly performed tasks by the user-controllable device.

Optionally, the at least one artificial intelligence engine further comprises a second audio-based artificial intelligence engine configured to determine a mood of the user based on the voice input received therefrom. Herein, the user-controllable device may be used to test the user, wherein a series of questions may be asked to the user and the mood of the user may be extracted to determine the level of satisfaction experienced by the user. For instance, in the case of testing, the user reads some material as part of training, and a quiz is provided at end of the material. Herein, in addition to the user getting a score based on the performance of the user, the system may measure other nonverbal aspects of speech using the second audio-based artificial intelligence engine, such as confidence, indecision, happiness, frustration, or stress of the user. Additionally, the mood of the user is determined to reflect an affective state the user is currently experiencing, which involves physiological reactions, thereby modifying different aspects of the voice production process.

Optionally, the first audio-based artificial intelligence engine is configured to remap a given voice input to automate a set of tasks of the user-controllable device. Herein, a generic command for a user could mean saving a file, and for another using the same generic command could mean opening a given website. Furthermore, a configuration file is installed in the user-controllable device, wherein the configuration file makes it possible to reprogram the commands by the user instead of having hard-wired commands. For a particular mode in a program, the commands are tied to specific functions. Moreover, the number of functions is larger than the number of commands so that the configuration file depends on the user profiles. Additionally, multiple functions may be grouped into a macro, wherein a command invokes a macro rather than a function. The configuration file is used to architect the system where the specific artificial intelligence engines currently present in the system are specified in the configuration file. This allows to scale up multiple versions of the system depending on the use case and the required complexity. Optionally, the configuration file is further used to architect the system where the at least one artificial intelligence engine present in the system is specified in the configuration file, thereby allowing to scale up the system depending on use case and the required complexity.

The present disclosure also relates to the method as described above. Various embodiments and variants disclosed above apply mutatis mutandis to the method.

Optionally, the method further comprises generating and maintaining a log file to record at least one of:
inputs/outputs to/of the master finite state machine;
inputs/outputs to/of the at least one artificial intelligence engine; and/or
multiple states of the master finite state machine.

Optionally, the at least one artificial intelligence engine further comprises at least one of: a video-based artificial intelligence engine, a sensor-based artificial intelligence engine.

Optionally, the method comprises receiving a video input to determine at least one function of the user-controllable device.

Optionally, the method comprises providing the predefined set of operations and function selection on a visual overlayer on the user-controllable device.

Optionally, the method comprises selectively activating the at least one artificial intelligence engine based upon a current state thereof.

Optionally, the master finite state machine and the predefined set of operations are optimized based on the user-controllable device.

Optionally, the method comprises using the at least one audio-based artificial intelligence engine to determine a context of the voice input using at least one of: state diagram, flow diagram, classical graph theory.

Optionally, the method comprises using the at least one audio-based artificial intelligence system to enable conversational interactions with the user by employing the determined context of the voice input.

Optionally, the method comprises enabling selection of a user profile from a user profile database.

Optionally, the method comprises generating the master finite state machine using a scripting language.

Optionally, the method comprises configuring the at least one audio-based artificial intelligence engine to remap a given voice input to automate a set of tasks of the user-controllable device.

### DETAILED DESCRIPTION OF THE DRAWINGS

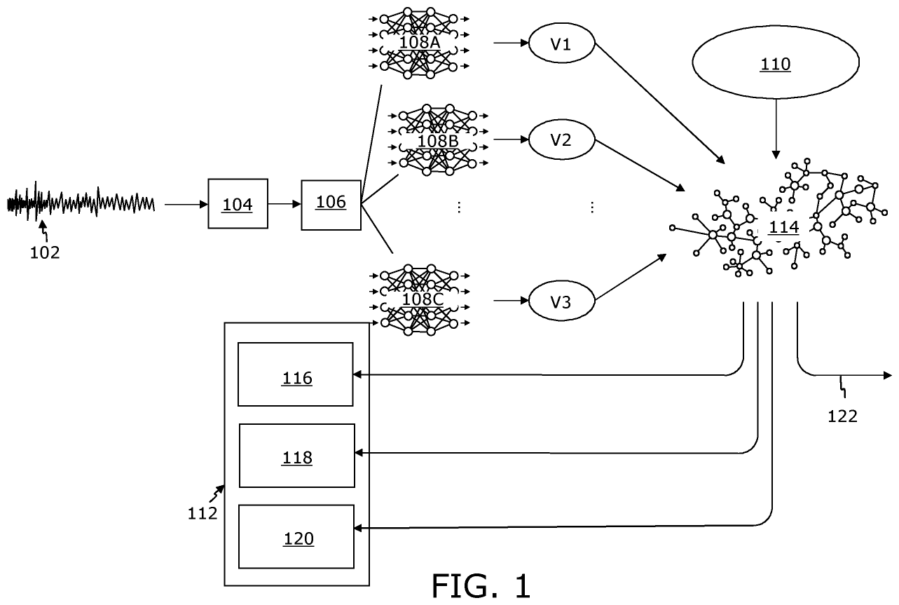

Referring to FIG. 1, there is shown a figure of a system 100 for managing a user-controllable device, in accordance with an embodiment of the present disclosure. Herein, a voice-input 102 is provided to an automated speech recognition 104. Subsequently, the automated speech recognition 104 converts the voice-input 102 into text 106. Thereafter, text 106 undergoes natural language processing (NLP) to extract information 108A, 108B, and 108C from the voice-input 102. Consequently, values denoted by “V1”, “V2” and “V3” are assigned to internal state variables, based on outputs of the extracted information 108A, 108B, and 108C via the NLP. Typically, system 100 comprises prior knowledge 110 pre-stored in system 100, wherein the knowledge comprises information specific to the application for which the system 100 is designed. Consequently, the values denoted by “V1”, “V2” and “V3” assigned to internal state variables, prior knowledge 110, and the current state of the system 100 are used to determine output 112 of the system 100 using a master finite state machine 114. Herein, the output 112 may be in the form of an audio message 116, a visual message 118, a payment gateway 120, or an alternate output 122 to an internal user.

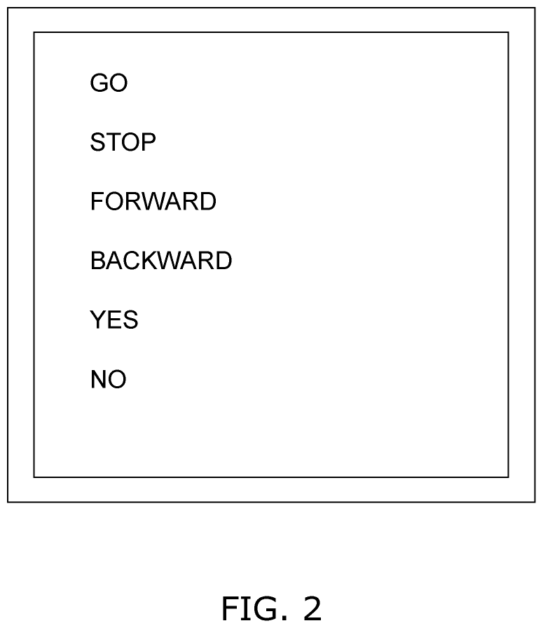

Referring to FIG. 2, there is shown a block diagram comprising a predefined set of operations, in accordance with an embodiment of the present disclosure. In an exemplary scenario, the predefined set of operations may comprise the following commands given by keywords, “GO”, “STOP”, “FORWARD”, “BACKWARD”, “YES” and “NO”. These keywords correspond to repeated action performed by a user upon interaction with the user-controllable device.

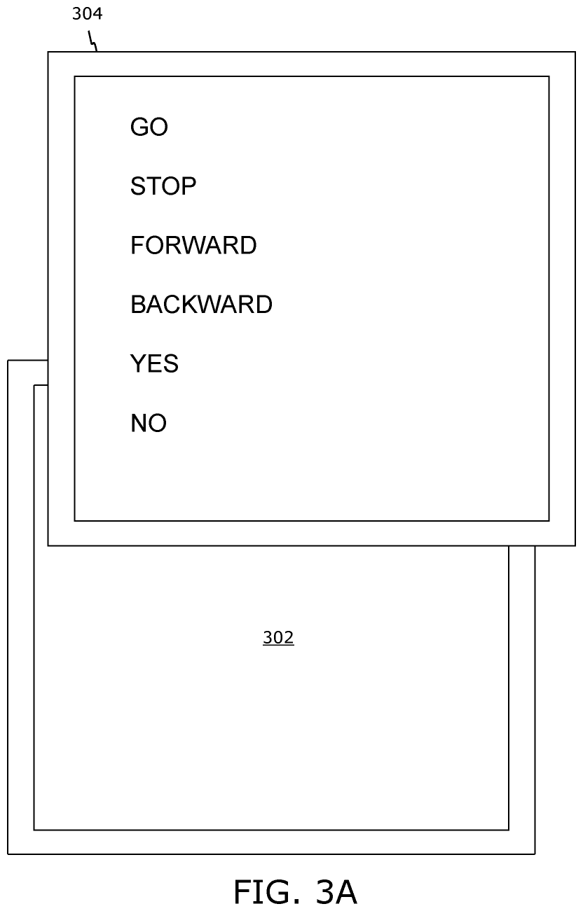

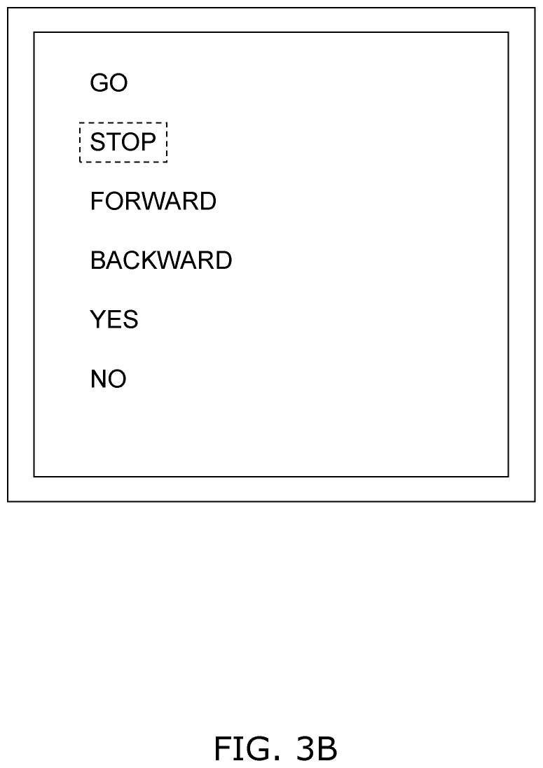

Referring to FIGS. 3A and 3B, there is shown an illustration of visual overlayer 302, in accordance with an embodiment of the present disclosure. Herein, the visible overlayer 302 enables printing the predefined set of operations 304 on any screen indicating to the user possible operations from the predefined set of operations 304. The visible overlayer 302 provides output as determined by a function implemented by the operation selected by the user from the predefined set of operations 304. Furthermore, the visible overlayer 302 provides feedback by highlighting a command once the command is given by the user, showing that the command is understood. The command is highlighted for a couple of seconds (as shown by the dotted lines).

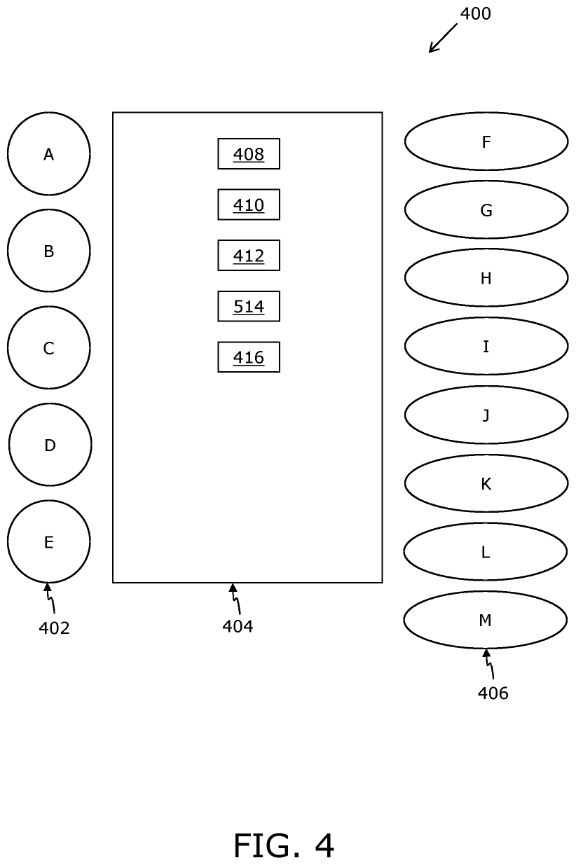

Referring to FIG. 4, there is shown a lookup table 400 of a configuration file, in accordance with an embodiment of the present disclosure. Herein, the lookup table 400 comprises a reduced command set 402, a configuration file 404, and a group of functions 406 to be executed according to each command. Herein, the reduced command set 402 comprises commands “A”, “B”, “C”, “D” and “E”. Furthermore, the group of functions 406 comprises the functions “F”, “G”, “H”, “I”, “J”, “K”, “L”, “M”. Herein, the group of functions 406 is more than the reduced command set 402. Additionally, configuration file 404 connects the command with the required function. The configuration file 404 may connect command “A” with function “F” 408, command “B” with function “G” 410, command “C” with function “H” 412, command “D” with the function “I” 414 and command “E” with function “J” 416.

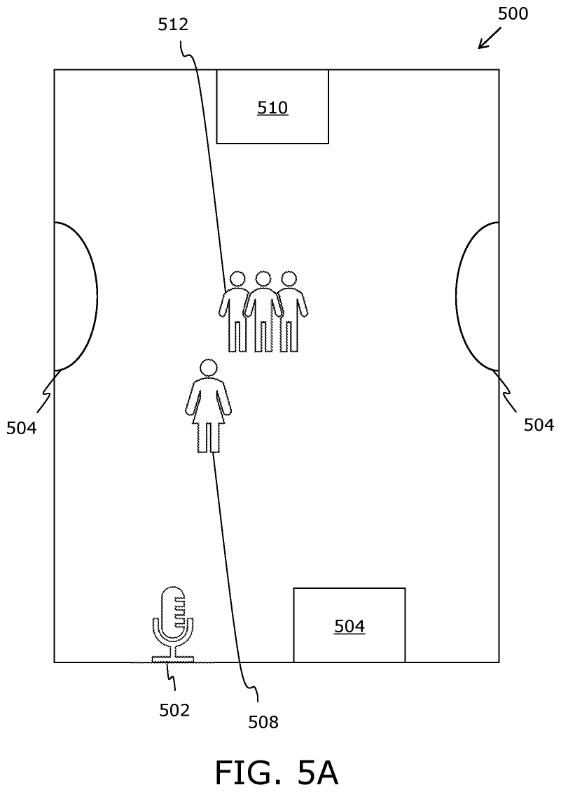

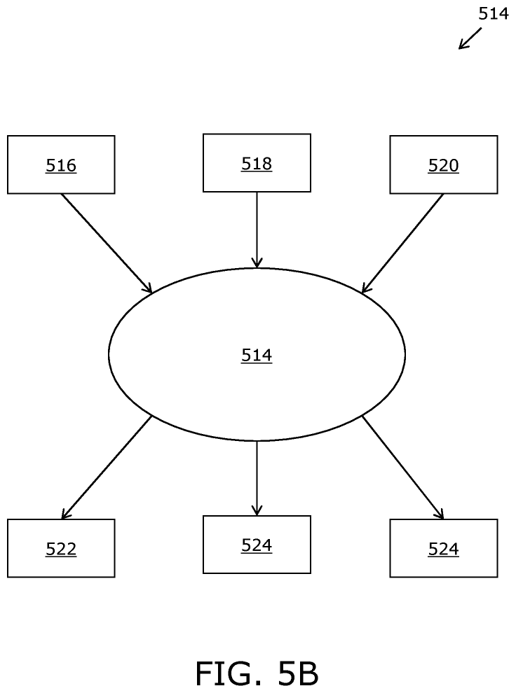

Referring to FIG. 5A, there is shown an exemplary illustration of a user-controllable device 500, in accordance with an embodiment of the present disclosure. The user-controllable device 500 may be an elevator in a multistoried residential building. A touchless interface is implemented inside the elevator, wherein the touchless interface comprises a microphone 502, at least one speaker 504, and a screen 506. The user-controllable device 500 uses the at least one speaker 504 to enquire a user 508 about floor that the user 508 wants to reach, and displays voice input received by the user 508 on the screen 506. The voice input is received from the user 508 using the microphone 502. The user-controllable device 500 further comprises a camera 510 that may be used for eye tracking, incase multiple individuals 512 are present in the elevator and the user-controllable device 500 is unable to distinguish among the different inputs received by the multiple individuals 512.

Referring to FIG. 5B, there is shown inputs and outputs of a master finite state machine 514 as implemented by the user-controllable device 500, in accordance with an embodiment of the present disclosure. The master finite state machine 514 transitions from one state to another in response to some inputs. Herein, a first input 516 is provided to the master finite state machine 514, wherein the first input 516 is the voice input of the user 508 configured by a first audio-based artificial intelligence engine. A second input 518 is provided to the master finite state machine 514, wherein the second input 518 is from the camera 510 which is configured by the video-based artificial intelligence engine to identify the user 508. A third input 520 is provided to the master finite state machine 514, wherein the third input 520 may be detection of blockage of doorway of the elevator by a person or an object which is configured by a sensor-based artificial intelligence engine. Thereafter, the master finite state machine 514 determines at least one function of the user-controllable device 500 based on the voice input received by the user 508, using the first input 516, the second input 518 and the third input 520. The at least one function based on the voice input may comprise a first output 522, wherein the first output 522 drives display of the screen 504. Furthermore, the at least one function based on the voice input may comprise a second output 524, wherein the second output 524 is a response to the user 508 using the at least one speaker 504. Additionally, the at least one function based on the voice input may comprise a third output 524, wherein the third output 524 controls the elevator.

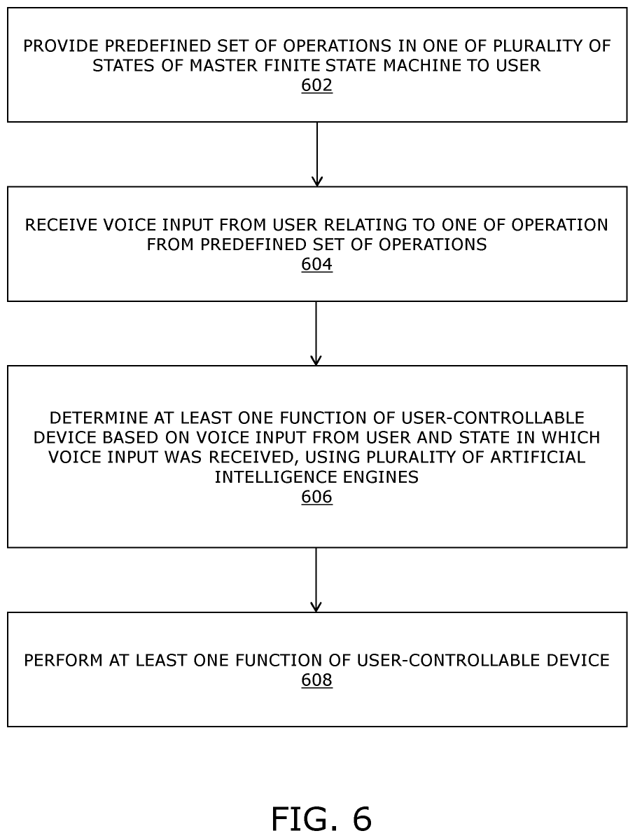

Referring to FIG. 6, illustrated is a flowchart depicting steps of a method for managing a user-controllable device, in accordance with an embodiment of the present disclosure. At step 602, a predefined set of operations is provided in one of a plurality of states of the master finite state machine to the user. At step 604, voice input is received from a user relating to one of an operation from the predefined set of operations. At step 606, at least one function of the user-controllable device is determined based on the voice input from the user and the state in which the input was received, using at least one of the audio-based artificial intelligence engines or the video-based artificial intelligence engine. At step 608, at least one function of the user-controllable device is performed.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components, or elements not explicitly described also to be present. Reference to the singular is also to be construed to relate to the plural.

In an embodiment a set of rules can be used to filter the data coming into any of the AI engines. The rules are used build a cleaner data set in a quicker way. Often, data is captured from sensors like microphone, camera, temperature, pressure . . . etc. A rule can be used on the values coming from the sensors. A typical flow is where the output of a sensor is converted to a digital value through an A/D converter, and a filter is used to filter noise or unwanted signals. Then rules are applied on the data. A rule can be implemented in hardware or software. The rule can be used as a condition of interest through the sensor. Rules can be implemented in software code running at a processor or DSP where a range of values can be specified or values above/below a certain threshold. Based on the set of rules actions can be taken and the quality of data reaching AI engines described in this invention is enhanced. An example is a case where a voice driven application is implemented in a mobile device using the invention described. The voice AI engine is actively waiting for a voice command. However, after some time (i.e., a rule) the AI engine goes to sleep mode to save power and waits until an acceptable input comes to wake the engine. Assume that a whistle comes through the input. A rule indicating that noises above certain dB level are not accepted. As a result the audio AI engine continues in sleep mode until an actual command comes along. Another result is the data set under which the AI engine is trained is constrained, making it smaller and enhancing the quality of the data under which the AI gets to be trained. Also this combination permits development of low power edge devices operating on AI applications.

1.-20. (canceled)

21. A system for managing a user-controllable device, the system comprising
at least one artificial intelligence engine comprising at least a first audio-based artificial intelligence engine; and
at least one processor implementing a master finite state machine in software, wherein the at least one processor is configured to:
provide a predefined set of operations in one of a plurality of states of the master finite state machine to the user;
receive voice input from the user relating to one of an operation from the predefined set of operations;
determine at least one function of the user-controllable device based on the voice input from the user and state in which the voice input was received, using the at least one artificial intelligence engine; and
perform the at least one function of the user-controllable device.

22. The system of claim 21, wherein the at least one processor is further configured to generate and maintain a log file to record at least one of:
inputs/outputs to/of the master finite state machine;
inputs/outputs to/of the at least one artificial intelligence engine; and/or
the plurality of states of the master finite state machine.

23. The system of claim 21, wherein the at least one artificial intelligence engine further comprises at least one of: a video-based artificial intelligence engine, a sensor-based artificial intelligence engine.

24. The system of claim 23, wherein the at least one processor is further configured to receive a video input to determine at least one function of the user-controllable device.

25. The system of claim 21, wherein the at least one processor comprises providing the predefined set of operations and function selection on a visual overlayer on the user-controllable device.

26. The system of claim 21, wherein the master finite state machine is configured to selectively activate the at least one artificial intelligence engine based upon a current state thereof.

27. The system of claim 21, wherein the master finite state machine and the predefined set of operations are optimized based on the user-controllable device.

28. The system of claim 21, wherein the first audio-based artificial intelligence engine is configured to determine a context of the voice input using at least one of state diagram, flow diagram, classical graph theory.

29. The system of claim 28, wherein the audio-based artificial intelligence system is configured to enable conversational interactions with the user by employing the determined context of the voice input.

30. The system of claim 21, wherein the at least one processor is configured to enable selection of a user profile from a user profile database.

31. The system of claim 21, wherein the at least one artificial intelligence engine further comprises a second audio-based artificial intelligence engine configured to determine a mood of the user based on the voice input received therefrom.

32. The system of claim 21, wherein the master finite state machine is generated using a scripting language.

33. The system of claim 21, wherein the first audio-based artificial intelligence engine is configured to remap a given voice input to automate a set of tasks of the user-controllable device.

34. The system of claim 21, wherein the user-controllable device is an edge computing device.

35. The method for managing a user-controllable device, wherein the method is implemented using a system comprising at least one artificial intelligence engine comprising at least one audio-based artificial intelligence engine; and at least one processor implemented as a master finite state machine in software, the method comprising
providing a predefined set of operations in one of a plurality of states of the master finite state machine to the user;
receiving voice input from the user relating to one of an operation from the predefined set of operations;
determining at least one function of the user-controllable device based on the voice input from the user and state in which the voice input was received, using at least one artificial intelligence engine; and
performing the at least one function of the user-controllable device.

36. The method of claim 35, wherein the method further comprises generating and maintaining a log file to record at least one of:
inputs/outputs to/of the master finite state machine;
inputs/outputs to/of the at least one artificial intelligence engine; and/or
multiple states of the master finite state machine.

37. The method of claim 35, wherein the at least one artificial intelligence engine further comprises at least one of: a video-based artificial intelligence engine, a sensor-based artificial intelligence engine.

38. The method of claim 37, wherein the method comprises receiving a video input to determine at least one function of the user-controllable device.

39. The method of any of the claim 15, wherein the method comprises providing the predefined set of operations and function selection on a visual overlayer on the user-controllable device.

40. The method of any of the claim 15, wherein the method comprises selectively activating the at least one artificial intelligence engine based upon a current state thereof.
